(19) United States
(12) Patent Application Publication
(10) Pub. No.: US 2016/0018802 A1
(43) Pub. Date: Jan. 21, 2016

(54) Measuring device and a measuring method for the synchronisation of measurement procedures

(71) Applicant: Rohde & Schwarz GmbH & Co. KG, Munich (DE)

(72) Inventor: Anton Strohmeier, Munich (DE)

(21) Appl. No.: 14/802,708

(22) Filed: Jul. 17, 2015

(30) Foreign Application Priority Data
Jul. 18, 2014 (DE) 102014214025.0

(51) Int. Cl. G05B 15/02

(52) U.S. Cl. CPC G05B 15/02

(57) ABSTRACT

A measuring device contains a measuring unit, a control unit and a communications unit. In this context, the measuring unit is embodied to be controlled by means of the communications unit and the control unit by control computers in order to execute measurement procedures. The measuring unit and/or the control unit accordingly have at their disposal at least one unit of a resource which can be used only by one measurement procedure at a time. The control unit is further embodied, after a reservation of the at least one unit of the resource by a control computer, to use the reserved unit of the resource only for measurement procedures triggered by the reserving control computer.

### PRIORITY

This application claims priority of German patent application DE 10 2014 214 025.0 filed on Jul. 18, 2014, which is incorporated by reference herewith.

### FIELD OF THE INVENTION

The invention relates to a measuring device and a measuring method in which a measuring device is controlled by at least two control computers in order to implement measurement procedures.

### BACKGROUND OF THE INVENTION

Especially in production environments, a measuring device is often used for the implementation of parallel measurements on several devices under test. In this context, several control computers have access to the measuring device and cause it to implement the measurements. Often, a control computer is used for each device under test to be measured. In order to achieve a reliably error-free operation of the measuring device, it has so far been necessary in this context to keep all of the resources of the measuring device in a corresponding number of control computers, because otherwise, an overlapping of measurement procedures in an insufficient number of available resources could occur, and accordingly, a falsification of the measurements could occur.

For example, DE 10 2011 084 143 A1 shows a measuring system in which a control computer controls a device under test and a measuring device in order to perform a measurement of the device under test. However, if several devices under test are to be measured by the measuring device with the assistance of several control computers, the above named German patent application does not allow any possibility for the use of resources of the measuring device in a cooperative manner.

With the prior art, it is therefore necessary to keep all of the resources of the measuring device in large numbers in order to be able to implement several measurements in parallel. Otherwise, there is a risk of error measurements.

The invention is based upon one object of providing a measuring device, a measuring system and a measuring method which allow a control by at least two control computers and, at the same time, achieve a minimal resource utilisation and a high level of reliability of the measurements.

### SUMMARY OF THE INVENTION

Accordingly, a measuring device according to any aspect of the invention contains a measuring unit, a control unit and a communications unit. In this context, the measuring unit is embodied to be controlled, by means of the communications unit and the control unit, by control computers in order to execute measurement procedures. In this context, the measuring unit and/or the control unit have at their disposal at least one unit of a resource which can be used only by one measurement procedure at a time.

Furthermore, the control unit is preferably embodied, after a reservation of the at least one unit of the resource by a control computer, to use the reserved unit of the resource only for measurement procedures triggered by the reserving control computer. This ensures that a resource kept in small numbers which can be used only by one measurement procedure at a time, is used reliably only by one measurement procedure at the same time. Accordingly, it is possible to dispense with keeping multiples of the resource and, at the same time, to achieve a high level of security of the measurement.

Advantageously, the measuring unit and/or the control unit have at their disposal several units of the at least one resource. In this case, the control unit is embodied, in the case of a reservation of one or more units of the resource by one or more control computers, to determine the still available number of units of the resource, to use reserved units of the resource only for measurement procedures which have been triggered by the respectively reserving control computer, and to use only available units of the resource for measurement procedures which are triggered by arbitrary control computers. In this manner, it is possible to keep the resource in multiple versions and, accordingly, to increase the availability of the measuring device and, at the same time, to guarantee the security of the measurements.

By preference, the control unit is embodied to use a reserved unit of the resource by measurement procedures not triggered by the reserving control computer only after a release of the reserved unit of the resource by the reserving control computer and/or after an expiry of a specified first time duration. On the one hand, this ensures that no overlapping of measurement procedures takes place in the unit of the resource. On the other hand, monitoring the expiry of the first time duration ensures that an accidental failure of a release does not lead to a permanent blocking of the resource.

By preference, the control unit is further embodied, in the event of a reservation attempt by a control computer at a time at which no unit of the resource is available, to communicate this to the respective control computer. This means that the control computer need not wait an unnecessarily long time for the allocation of the resource, but can prioritise other processing steps.

Advantageously, in this context, the units of the resource are measurement paths or processors or buffers or analog-digital converters or frequency converters or analysers. Numerous other modules of the measuring device can also be used as units of the resource. Accordingly, a great flexibility is possible in the use of the measuring device and the measuring method.

By preference, a reservation of a unit of the resource and a release of a unit of the resource are implemented in this context by means of SCPI commands from the respective control computer to the measuring device. With the use of the SCPI standard, the measuring device according to the invention and the measuring method according to the invention can be integrated simply into existing measuring systems.

By preference, the measuring device is further embodied, in the event of a reservation of a unit of the resource, to transmit a key to a reserving control computer, and to implement a release of the unit of the resource only after communication of the key by the reserving control computer. This ensures that the resource cannot be reserved by a control computer other than the reserving control computer. This is particularly relevant if the resource is accidentally used by two different computers at the same time because of a communications error. In the event of an attempted release by an unauthorised control computer, the measuring device and the control computers notice that several control computers have sought access to the resource simultaneously and the measurement results must therefore be doubted.

By preference, the measuring unit is embodied in this context for the simultaneous implementation of measurements on several devices under test. Accordingly, the control unit has at its disposal a synchronisation unit which is embodied, after a first synchronisation point, to determine a number L of completed measurement procedures up to the expiry of a second time interval after the completion of a first measurement procedure, and, after a second synchronisation point to wait until an expiry of the second time interval after the completion of a first measurement procedure or until the completion of L measurement procedures. This ensures that, in the case of a measurement of several devices under test, the process does not wait an unnecessarily long time for measurement results of one device under test if earlier measurements on this device under test have already been unsuccessful. This reduces the measurement time and accordingly allows a higher throughput of devices under test.

The measuring system according to another aspect of the invention comprises a measuring device, as previously described, and at least two control computers. In this context, the control computers are embodied to control the measuring device, to reserve units of the resource and to use units of the resource only if a reservation of the unit of the resource has been successful. In this manner, a resource-saving and secure measurement is guaranteed.

By preference, instead of several control computers, several processes within one control computer or even several threads within a processor can be used.

A measuring method according to the invention serves for the measurement of at least one device under test. Accordingly, a measuring device is controlled by control computers. The measuring device in this context has at its disposal at least one unit of a resource which can be used only by one measurement procedure at a time. After a reservation of a unit of the resource by a control computer, the reserved unit of the resource is used only for measurement procedures triggered by the reserving control computer. This means that the resource only needs to be reserved in small numbers, and, at the same time, a high security level of the measurements can be achieved.

In this context, a measurement procedure is a complete measurement, a partial measurement or a processing step which is implemented within a measurement or a partial measurement.

### BRIEF DESCRIPTION OF THE DRAWINGS

In the following, the invention is described with reference to the drawings in which an advantageous to exemplary embodiment of the invention is illustrated by way of example only. The drawings show:

FIG. 1 a first exemplary embodiment of the measuring device according to the invention within a measuring system;

FIG. 2 a second exemplary embodiment of the measuring device according to the invention in a block-circuit diagram;

FIG. 3 a third exemplary embodiment of the measuring device according to the invention in a detail view;

FIG. 4 a flow chart of a first exemplary embodiment of the measuring method according to the invention;

FIG. 5 a flow chart of a second exemplary embodiment of the measuring method according to the invention; and

FIG. 6 a flow chart of a third exemplary embodiment of the measuring method according to the invention.

### DETAILED DESCRIPTION OF PREFERRED EMBODIMENTS

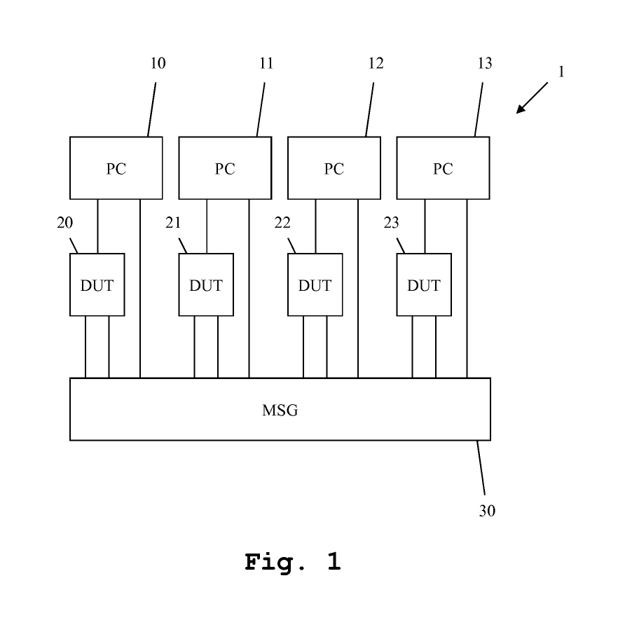

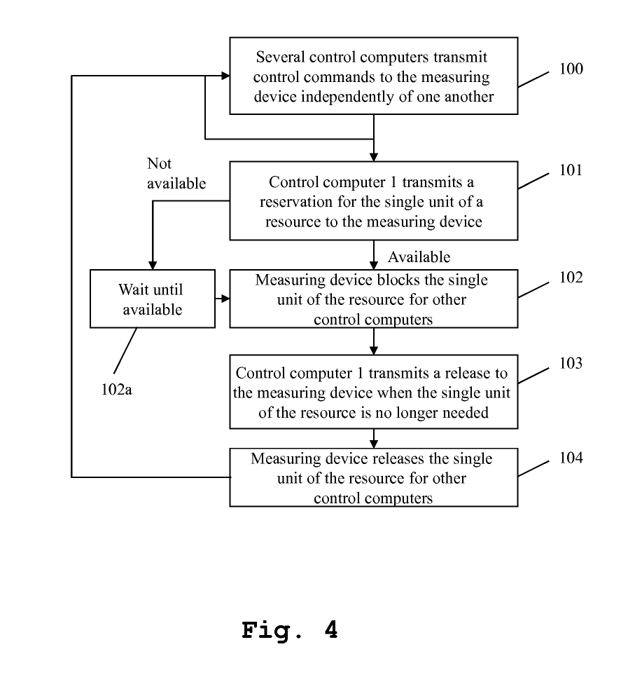

Initially, the construction and functioning of different exemplary embodiments of the measuring device according to the invention will be described with reference to FIGS. 1-3. Following this, the functioning of different exemplary embodiments of the measuring method according to the invention will be described with reference to FIG. 4-FIG. 6. The presentation and description of identical elements in similar drawings have not been repeated in some cases.

FIG. 1 shows a first exemplary embodiment of the measuring device 30 according to the invention in a measuring system 1. The measuring system 1 contains the measuring device 30, a first control computer 10, a second control computer 11, a third control computer 12 and a fourth control computer 13. These control computers 10-13 are each connected to the measuring device 30. This connection is preferably made by means of a data line or with a wireless connection. Devices under test 20-23 are connected to the measuring system 1. Accordingly, each device under test 20-23 is connected to a control computer 10-13. This connection is also preferably a data line. Furthermore, each device under test 20-23 is connected to the measuring device 30. This connection is preferably a bidirectional high-frequency line.

In this context, the control computers 10-13 control the devices under test 20-23 and the measuring device 30. The measuring device 30 transmits measurement signals under the control of the control computers 10-13 to the devices under test 20-23 and receives resulting output signals from the devices under test 20-23. The measuring device 30 determines measurement results from the received output signals of the devices under test 20-23 and transmits these to the control computer 10-13 connected in each case to the device under test 20-23 measured.

With regard to the detailed functioning and the detailed construction, reference is made to the following Figs.

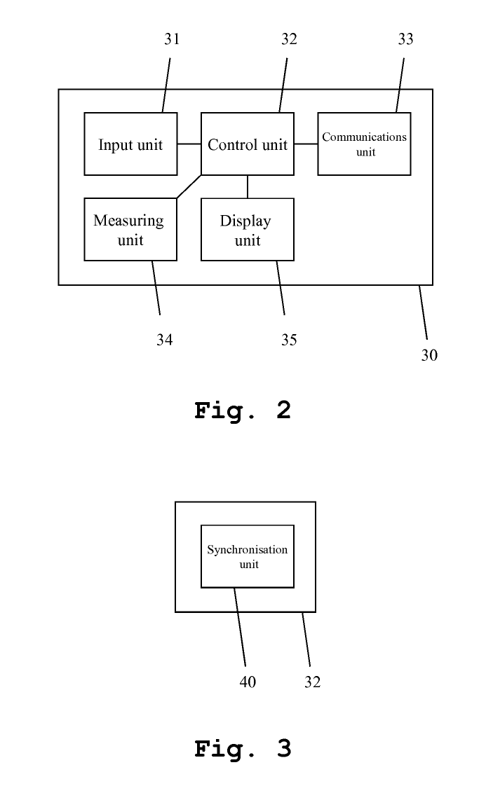

FIG. 2 shows a block-circuit diagram of a second exemplary embodiment of the measuring device 30 according to the invention. Here, the internal construction of the measuring device 30 is shown. The measuring device 30 in this context contains an entry unit 31, a control unit 32, a communications unit 33, a measuring unit 34 and a display unit 35. All of the units 31, 33-35 are connected in this context respectively to the control unit 32.

The entry unit 31 serves accordingly for receiving user entries. The control unit 32 is used for the processing of information communicated from all of the other units 31, 33-35, for the general control of the measuring device 30 and for generating information for the respective units 31, 33-35. The communications unit 33 serves accordingly for communication with the control computers 10-13 from FIG. 1. The measuring unit 34 is used to generate the measurement signals which are supplied to the devices under test 20-23 from FIG. 1 and to process the output signals of the devices under test 20-23 from FIG. 1. The display unit 35 in this context is used for the display of measurement results and user dialogues.

FIG. 3 shows a third exemplary embodiment of the measuring device according to the invention in a detailed view. Here, only a part of the internal construction of the control unit 32 is shown. Accordingly, the control unit 32 contains a synchronisation unit 40. The synchronisation unit 40 in this context is used for monitoring of measurement processes and synchronisation of measurement processes between measurement procedures, which are triggered by different control computers 10-13.

With regard to detailed functioning, reference is made to the description relating to FIGS. 4-6.

FIG. 4 shows a flow chart of a first exemplary embodiment of the measuring method according to the invention. In a first step 100, several control computers independently of one another transmit control commands to the measuring device. Provided these control commands are control commands capable of being processed by the measuring device without difficulty in parallel, the first step 100 is repeated. However, as soon as the control commands include control commands which require a unit of a resource which can only be used by one control computer at a time, in a second step 101, the respective control computer transmits a reservation for a unit of the resource to the measuring device.

If the unit of the resource is available, in a third step 102, the measuring device blocks the unit of the resource for other control computers. However, if the resource is not available, in a step 102a, the process waits until the unit of the resource is available. It continues with the third step 102.

Alternatively, the control computer can continue working through steps which do not require the unit of the resource. Following this, it is possible to continue with a new execution of the second step 101.

When the reserving control computer no longer requires the unit of the resource, it transmits a release to the measuring device, in a fourth step 103. The measuring device reacts to this in a fifth step 104 with a release of the resource for other control computers.

This procedure ensures that the critical resource is not accidentally used by several control computers simultaneously, which, in this case, could possibly access incorrect data. At the same time, this means that the critical resource only needs to be reserved once.

In this context, the reservation of a unit of a resource as described with reference to FIG. 4 can be regarded as the Boolean object mutex. Accordingly, such a mutex can be seen as a barrier which is either open or closed. A mutex of this kind can protect a part of a measurement procedure, for example, a program.

A mutex of this kind is accordingly used as follows:

1) Critical sections of the measurement process or respectively of the program are identified.

2) The definition of a mutex is integrated in a preamble of the measurement process.

3) The critical section of the measurement process or respectively of the program is framed between a reservation (LOCK) and a release (UNLOCK). When the measurement process or respectively the program are executed, and a LOCK command is passed, and the corresponding mutex is disposed in the UNLOCKED status, the status is changed to LOCKED. The process can now run through the critical section. When the last command of the critical section has been worked through, the UNLOCK command is passed, which releases the mutex. Any other processes which attempt to reserve the mutex and accordingly to place it into the LOCKED status, while it is already in the LOCKED status, must wait until the mutex switches back into the UNLOCKED status.

In general, the following steps are run through, in order to achieve a cooperative use of a mutex:
A mutex is defined for every critical situation with the use of the DEFINITION command
At the start of every critical section, the execution must wait until the section has been released. The start of the critical section is identified in this context on the basis of the LOCK command. When LOCK command occurs, the procedure is as follows:
   Check whether the section is reserved
   Reserve the section with a LOCK command and accordingly move into the LOCKED status if the section is free.
   These two steps must be implemented in an inseparable manner so that no other process can intrude.
In order to release a critical section after the execution, the UNLOCK command is used. To reduce any unnecessary storage requirement, the mutex can be deleted by means of UNDEFINITION command after it has been executed, if all instances of the program have passed the critical region.

In many situations, it may be meaningful not to wait until a critical section is free but, instead, to prioritise another task and to check again later whether the section is free. This can be achieved by means of the STATE command which is capable of locking automatically if the section is currently free. Furthermore, the CATALOG command allows a check to be carried out regarding which mutexes are currently set up.

The behaviour of a mutex will be described in detail in the following:
A mutex which is free (UNLOCKED) can be reserved (LOCKED) without the need for a waiting time.
A mutex which is reserved (LOCKED) cannot be reserved (LOCKED) again. Each attempted reservation (Lock Attempt) by another process results in the other process waiting until the mutex has been released (UNLOCKED) by the previous process or until a first time duration has elapsed (Timeout).
If several processes have transmitted a reservation (LOCK command) and are waiting for the mutex to be released (UNLOCKED), it is not predictable which process will come next in the sequence. However, it is guaranteed that only one process will take over the mutex.
A mutex can be released (UNLOCKED) only by means of a valid, unambiguous key or a universal key. A valid, unique key is transmitted by the mutex to the process in response to the reservation.
The status of a mutex can be interrogated without having to incur a waiting time.
The status of a mutex can be requested and, at the same time, the mutex can be reserved with only a single command.
A mutex can only be re-defined if it is not reserved (LOCKED).
A re-definition with a different active range (scope) is not allowed and results in an SCPI error. In this context, the scope relates to a partial measuring device or an entire measuring device.
A re-definition of a mutex is only allowed in order to change the time duration (timeout value).
A mutex is not storage-persistent. It does not persist beyond a switching off of the device. It must be defined at the beginning of a program.

In the following, the individual commands for generating a mutex, as outlined above, will be described in detail:

DEFINITION

The DEFINITION command defines a mutex or re-defines a mutex. In this context, three different features must be defined:
Name:

The name is a string which is used to identify the mutex within the system. The name must be unambiguous within the scope. That is, the name must occur only a single time within the measuring device.
defTimeout:

The timeout value sets the time duration t1 of the mutex. This relates to a numerical value in milliseconds. The value can be from one millisecond to five minutes. A mutex is normally released by means of the UNLOCKED command when the critical section of the program has been worked through. If this does not occur, the timeout value is reached. This represents an abnormal behaviour of the program. As a consequence, an SCPI error is generated.
Scope:

This variable defines the scope of the mutex and therefore specifies whether the mutex is defined globally for the entire measuring device or only for a sub-instrument.

UNDEFINITION

The UNDEFINITION command is the antagonist of the DEFINITION command. It removes a mutex from the system. It can only be used if the mutex is not reserved (UNLOCKED). The UNDEFINITION command has the name of the mutex as its single parameter.

LOCK

The purpose of a mutex is to protect a critical section of the measurement process or respectively program. Accordingly, it makes no sense to protect a section without waiting until it has been released. The LOCK command therefore asks whether the mutex has been released and interrupts the measurement process until the critical section has been released. That is, further SCPI commands are interrupted. As soon as this is the case, the mutex is again placed into the LOCKED status, wherein an unambiguous key is transferred to the program or respectively the control computer. Relevant parameters are the name of the mutex, an optional timeout which indicates the maximal duration of the Lock of the mutex, where this differs from the default time indicated in the definition, and the key, which relates to an integer number.

Purpose of the Key

If a first thread A reserves a mutex (LOCKED) and moves into the critical section, but the time duration t₁ then elapses, an SCPI error is generated, and the mutex is placed into the UNLOCKED status. In turn, an already waiting thread B now reserves the mutex and enters the critical section. However, if the thread A has not noticed this, the thread A could reach the end of the critical section and in turn place the mutex into the UNLOCKED condition, by releasing the mutex. This is prevented in that only the thread (process, control computer), which has reserved the mutex (LOCKED), can release (UNLOCKED) the mutex again. This is ensured by the key.

UNLOCK

If the program execution is about to leave a critical section, the critical section must be open for the next measurement process (program, thread). This is achieved by releasing the mutex by means of the UNLOCK command. The relevant parameters are the name of the mutex and the key.

STATE

If a critical section is reserved, it may be useful initially to implement other partial tasks of the measurement procedure instead of waiting until the critical section is free. In this case, the STATE command can be used. If a STATE command is transmitted to the measuring device, the measuring device transmits back whether the mutex is reserved (LOCKED) or released (UNLOCKED). On the basis of this information, the reserving control computer (program, thread) can decide whether another task is prioritised, or whether it should wait for the critical section. However, it may be problematic in this case that a further process can jump ahead of the transmitter of the STATE command if the STATE command transmits back a released (UNLOCKED) status of the mutex in its reply, and a reservation of the mutex is intended. For this purpose, an additional parameter can be added to the STATE command, which implements an automatic reservation (LOCKED) of the mutex if the status is released (UNLOCKED). Relevant parameters of the STATE command are the name of the mutex and whether an automatic reservation (LOCK) is to be implemented if the status is released (UNLOCKED).

CATALOG

The CATALOG command lists all mutexes which are valid in the present measuring device. All mutexes which have been defined with a global scope and a scope in the present sub-instrument are listed. The CATALOG command has no parameters in this context.

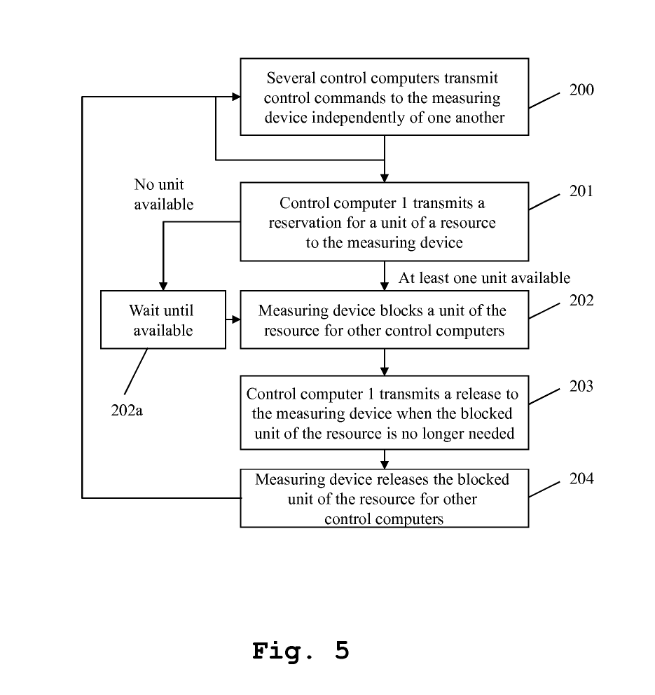

FIG. 5 shows a second exemplary embodiment of the method according to the invention. In a first step 200, several control computers independently of one another transmit control commands to the measuring device. In a second step 201, a first control computer transmits a reservation for a unit of a resource to the measuring device. In this context, the measuring device has at its disposal several units of the resource.

If at least one unit of the resource is available, in a third step 202, the measuring device blocks the reserved unit of the resource. However, if no unit of the resource is available, the control computer can wait, in a step 202a, until a unit of the resource is available and then continue with the third step 202. Alternatively, the control computer can prioritise other steps which do not require the resource and continue again later with the second step 201.

In a fourth step 203, the control computer transmits a release to the measuring device when the unit of the resource is no longer required. In response, the measuring device releases the unit of the resource for other control computers in a fifth step 204.

The method described with reference to FIG. 5 starts out with several units of a scarce resource. The term semaphore is often used in this context. A semaphore is used when resources are limited. If a measurement procedure, for example, a program, requires a resource for its execution, the consumption of the resource must be monitored and protected. This can be achieved in a simple manner through the use of the semaphore. Viewed from a technical perspective, a semaphore is a counting mutex. The semaphore is available (UNLOCKED) as long as units of the resource are available; and the semaphore is blocked, when no units of the resource are available.

In order to use a semaphore, a measurement procedure, for example, a process, acquires a unit of the resource with an ACQUIRE command. As soon as the resource is no longer required, the unit of the resource is released by means of a RELEASE command. The use of a semaphore in this context is very similar to the use of a mutex. In this context, the typical steps are identical:

1) All of the sections in a program code in which a scarce resource is used are identified.

2) A semaphore is specified for each of the sections. In this context, the definition contains the number of units of the resource which are available in parallel.

3) Each use of the scarce resource is framed in the measurement procedure or respectively program between an ACQUIRE command and a RELEASE command. As soon as a unit of the resource is used, this is indicated by an ACQUIRE command. As soon as the unit of the resource is no longer being used, it is released with a RELEASE command.

4) As soon as a semaphore is no longer being used, it can be deleted with an UNDEFINE command.

By analogy with a mutex, situations can occur in which it is more appropriate for the measurement procedure or respectively a program not to wait for a resource blocked by a semaphore but to prioritise other partial tasks. This can be achieved with an interrogation of the current status of the semaphore by means of a COUNT command.

Behaviour of a Semaphore:
Through the definition of the semaphore, the number of units of the resource and a process time (Timeout) are defined. They can be varied only by a re-definition of the semaphore.
A semaphore with a number of units >0 is available (UNLOCKED) and can be used immediately (ACQUIRED). No waiting time is required for this purpose.
A semaphore with a number of available resources=0 is blocked (LOCKED) and waits until the number of available units is >0. This occurs as soon as the next RELEASE command is executed.
If more than one ACQUIRE command is disposed in a waiting status when a resource is released, it is impossible to predict which ACQUIRE command will come in turn. However, it is guaranteed that only one process can use the unit of the resource.
The maximal waiting time t_{wait} with n parallel processes which use the resource for a time t_{T} is therefore t_{wait}<t−(n−1).

The present status with regard to the available units of the resource of a semaphore can be interrogated without the need for a waiting time. By analogy with the mutex, in which a LOCK command can be embedded in the status enquiry by means of the STATE command, in the case of a semaphore, an ACQUIRE command can be embedded in the COUNT command.

DEFINITION

The DEFINITION command defines the properties of a semaphore. Relevant parameters are the name of the semaphore which is used to identify the semaphore within the system. In this context, an unambiguous name must be used. A waiting time (Timeout) is also relevant. This is a numerical value in milliseconds which can be characterised from one millisecond up to five minutes. This is the time which is waited until a semaphore switches automatically into the available status (UNLOCKED), after it has been placed into the blocked status (LOCKED).

The number of units of the resource which are managed by the semaphore is also relevant. For this purpose, the variable COUNT is used. Valid values for this variable are 1-20. A further parameter of the semaphore is its active range (scope), which defines whether the semaphore acts in the entire measuring device or only in a sub-measuring device.

UNDEFINITION

The UNDEFINITION command is the antagonist of the DEFINITION command. It removes the semaphore from the system. If a semaphore is blocked or its present COUNT is not equal to the maximum number, the semaphore cannot be removed from the system. The single relevant parameter of the UNDEFINITION command is the name of the semaphore.

ACQUIRE

The purpose of a semaphore is to protect scarce resources. If a unit of a resource is available, it can be used immediately. If this is not the case, a measurement procedure or respectively thread must wait until the unit of the resource has become free again. The ACQUIRE command interrogates the internal condition of the semaphore and stops the measurement procedure or respectively the program until the semaphore switches into the available status (UNLOCKED). This is the case when the number of available units of the resource is >0. As soon as this occurs, the ACQUIRE command reduces the number of available units of the resource by one. If this unit of the resource is the last available unit of the resource, every further call up of ACQUIRE results in waiting. However, no resource is blocked. Only the further course of the program is prevented. In response to an ACQUIRE command, a key which is necessary for a RELEASE command of the semaphore is always communicated. The key is an integer value. All keys which are transmitted in response to an ACQUIRE command are valid for a release of the unit of the resource. The sequence of the release of the units of the resource is accordingly independent of the sequence of the reservation of the units of the resource. However, each key is valid only once.

RELEASE

As soon as a measurement procedure or respectively program has completed the use of the unit of the resource, it releases the resource with the use of the RELEASE command.

Relevant parameters of the RELEASE command in this context are only the name of the semaphore and the key which has been communicated in response to the ACQUIRE command.

COUNT

The COUNT command interrogates the present number of available units of the resource of the semaphore. It does not change the status of the semaphore. The single relevant parameter of the COUNT command is the name of the semaphore. In response to the COUNT command, an integer value of the available unit of the resource is returned.

CATALOG

The CATALOG command exists only for the sake of convenience. It lists all of the defined semaphores including their defined parameters. The CATALOG command accordingly has no parameters.

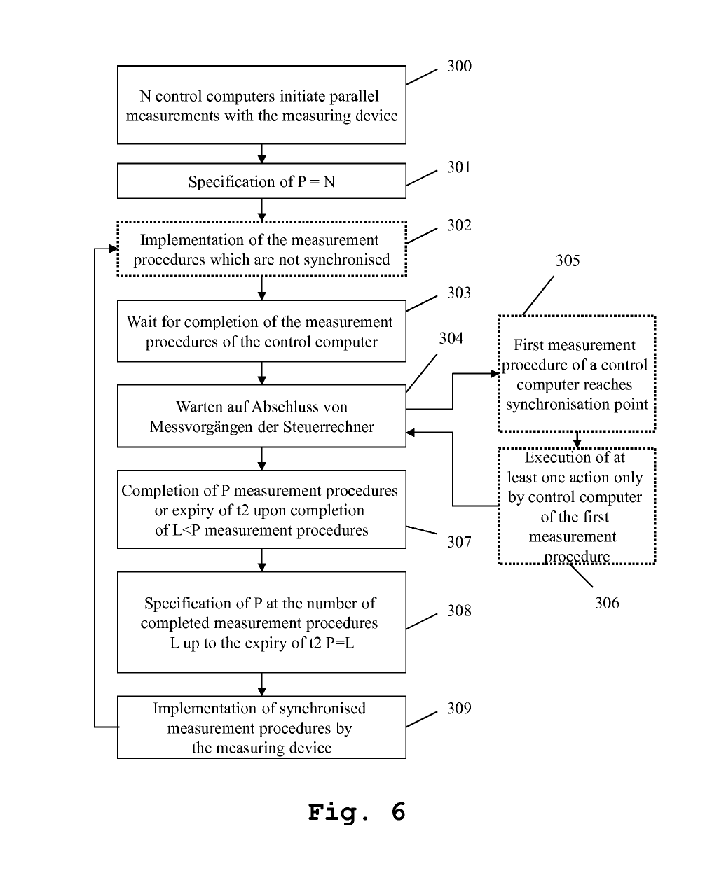

FIG. 6 shows a flow chart of a third exemplary embodiment of the measuring method according to the invention. In a first step 300, N control computers initiate parallel measurements with the measuring device on a number of devices under test. In a second step 301 in this context, a variable P is set to the value of N. In an optional third step 302, the measuring device implements non-synchronised measurement procedures on M devices under test. In this context, a measurement procedure is a measurement or a partial measurement or processing step. In a fourth step 303, a synchronisation point is reached. That is, measurement procedures should be synchronised at this point.

In a fifth step 304, the completion of already running measurement procedures is waited for. In an optional sixth step 305, one measurement procedure of a control computer among the already running measurement procedures is completed as the first measurement procedure. In an optional seventh step 306, the control computer of which the measurement procedure was completed first implements at least one action. This can be a preparation for a further process, for example, through the activation of a component of the measuring device or of a further measuring device.

In an eighth step 307, a check is carried out to determine whether all P measurement procedures have been completed. As soon as all P measurement procedures have been completed or a time duration t2 after the completion of a to first measurement procedure has elapsed, the process continues. In a ninth step 308, the variable P is set to a value L of completed measurement procedures unless all P measurement procedures have been completed within the time duration t2.

Following this, in a tenth step 309, synchronised measurement procedures are implemented. The method can now be repeated from the third step 302 arbitrarily often, in each case with a new synchronisation point.

That is to say, as soon as a synchronisation point has been fully processed, a check is carried out to determine how many measurement procedures L have been completed. In the case of further synchronisation points, the method does not necessarily wait any longer until the expiry of the time interval t2, but the measurement run is completed when as many completed measurement procedures have been detected as were determined at the preceding synchronisation point. In this manner, the measurement time can be dramatically reduced.

The method described above therefore uses a synchronisation point. A synchronisation point is used when several processes are to be synchronised before they are allowed to continue operating. This means that all processes wait until all processes have reached a synchronisation point or until a time interval t2 has elapsed. In order to use a synchronisation point, the JOIN command of the synchronisation point is called up.

In general, the following steps are implemented in this context:

1) All synchronisation points within a measurement process are identified and defined by means of a DEFINITION command.

2) A JOIN command is placed at every position of a synchronisation point in the respective measurement processes.

3) After the measurement process has been completed, the synchronisation point is deleted with an UNDEFINITION command.

In particular, if it is not clear how many processes will take place in the further processing, for example, because of different numbers of devices under test, it is possible to define only a maximal number M for the first synchronisation point, as in the example shown above. For all subsequent synchronisation points, the method will now continue with the correct number of processes or respectively devices under test as described above. Accordingly, there is no need to wait unnecessarily if it is already clear that the maximum number of processes or respectively devices under test cannot be reached.

Dependent upon the effort and the duration of the processing before the synchronisation point of up to several seconds, it can occur that a longer waiting time is necessary than with a conventional SCPI command. If a user does not wish to alter the general SCPI timeout, it is possible to achieve a longer waiting time without risking an SCPI timeout by means of a REWAIT command. An

SCPI timeout should be avoided in order to prevent a complete break in communication.

Behaviour of a synchronisation point:
The maximal number of expected processes or respectively devices under test and the specified process time (timeout) of a synchronisation point are set by its definitions. They can be changed only by a re-definition.
A synchronisation point is blocked if the number JOIN_COUNT, which corresponds to the number of processes which have reached the synchronisation point, is smaller than PROCESS_COUNT, which corresponds to the expected number of processes.
The synchronisation point is released when JOIN-COUNT≧PROCESS COUNT.

DEFINITION

A DEFINITION command sets the parameters of a synchronisation point. Relevant parameters are the name of the synchronisation point, which is a string which must be unambiguous within the measuring system. The parameter timeout (Timeout), which defines the time interval t2 from which a synchronisation point may be passed although the expected number of processes or respectively devices under test with successful measurement has not yet been reached, is also relevant. A further relevant parameter is the value of the expected processes or respectively successful measurements. Furthermore, the parameter scope (Scope) is relevant, which defines whether the synchronisation point acts globally or only within a present sub-instrument.

UNDEFINITION

The UNDEFINITION command is the antagonist of the DEFINITION command. It removes a synchronisation point from the system. The single relevant parameter is the name of the synchronisation point. The synchronisation point can only be deleted if no process has reached the synchronisation point yet, or respectively no successful measurement has yet been detected.

JOIN

The JOIN command represents the functionality of a synchronisation point. By calling up the JOIN command, a process waits for all other processes with which the process wishes to be synchronised. In this context, the name of the synchronisation point is called up as the relevant parameter of the JOIN command. As a result, a number of processes which have already reached the synchronisation point is returned. Furthermore, a status can be returned.

REWAIT

The REWAIT command serves for the solution of the problem described above of an excessively short timeout of the SCPI channel. The REWAIT command is called up in order to trigger a further waiting time of the SCPI standard. The single relevant parameter of the REWAIT command is the name of the corresponding synchronisation point. In response, the number of processes which have reached the synchronisation point and optionally a status is/are returned.

CATALOG

As in the case of the mutex and the semaphore, the CATALOG command can be used to call up all defined synchronisation points within the measuring device. In this context, the CATALOG command has no parameters. Accordingly, all of the names and other properties of the synchronisation points are returned.

In this context, the invention is not restricted to the exemplary embodiments presented. Arbitrary measuring devices, such as signal analysers, network analysers, logic analysers, signal generators, oscilloscopes etc. can be used. Furthermore, alongside the SCPI standard presented, a different communications standards can be used for the transmission of the messages. Advantageously, all of the features described above or features shown in the Figs. or features claimed in the claims can be combined with one another arbitrarily within the scope of the invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of the several implementations, such feature may be combined with one or more other features of the other implementations as may be desired and advantageous for any given or particular application.

What is claimed:

1. A measuring device with a measuring unit, a control unit and a communications unit,
wherein the measuring unit is embodied to be controlled by means of the communications unit and the control unit by control computers in order to execute to measurement procedures,
wherein the measuring unit or the control unit have at their disposal at least one unit of a resource, which can be used simultaneously by only one measurement procedure.

2. The measuring device according to claim 1,
wherein the control unit is embodied, after a reservation of the at least one unit of the resource by a control computer, to use the reserved unit of the resource only for measurement procedures triggered by the reserving control computer.

3. The measuring device according to claim 2,
wherein the measuring unit or the control unit have at their disposal several units of the at least one resource, and
wherein the control unit is embodied,
in the case of a reservation of one or more units of the resource by one or more control computers, to determine the number of units of the resource still available,
to use reserved units of the resource only for measurement procedures which are triggered by the respectively reserving control computers, and
to use only available units of the resource for measurement procedures which are triggered by arbitrary control computers.

4. The measuring device according to claim 2,
wherein the control unit is embodied to use the reserved unit of the resource by measurement procedures not triggered by the reserving control computer only after the release of a reserved unit of the resource by the reserving control computer and/or after an expiry of a specified first time interval.

5. The measuring device according to claim 2,
wherein in the case of a reservation attempt by a control computer at a time at which no unit of the resource is available, the control unit is embodied to communicate this to the respective control computer.

6. The measuring device according to claim 1,
wherein the units of the resource are measurement paths or processors or buffers or analog-digital converters or frequency converters or analysers.

7. The measuring device according to claim 1,
wherein a reservation of a unit of the resource and a release of a unit of the resource is implemented by means of SCPI commands from the respective control computer to the measuring device.

8. The measuring device according to claim 1,
wherein the measuring device is embodied,
to transmit a key to a reserving control computer in the case of a reservation of a unit of the resource, and
to implement a release of the unit of the resource only in the case of a communication of the key by the reserving control computer.

9. The measuring device according to claim 1,
wherein the measuring unit is embodied for the simultaneous implementation of measurement procedures on at least two devices under test, wherein the control unit has at its disposal a synchronisation unit, which is embodied,
after a first synchronisation point, to determine a number L of completed measurement procedures up to the expiry of a second time interval after the completion of a first measurement procedure, and,
after a second synchronisation point, to wait until an expiry of the second time interval after the completion of a first measurement procedure or until the completion of L measurement procedures.

10. A measuring system with a measuring device according to claims 1 and at least two control computers which are embodied to control the measuring device,
wherein the control computers are embodied,
to reserve units of the resource, and
to use units of the resource only if a reservation of the unit of the resource was successful.

11. A measuring method, wherein control computers control a measuring device for the execution of measurement procedures,
wherein the measuring device has at its disposal at least one unit of a resource which can be used only by one measurement procedure at a time.

12. The measuring method according to claim 11,
wherein the measuring method contains the following steps:
reservation of the at least one unit of the resource by a control computer,
use of the reserved unit of the resource only for measurement procedures triggered by the reserving control computer.

13. The measuring method according to claim 12,
wherein the measuring device has at its disposal several units of the at least one resource, and
wherein the measuring method contains the following further steps:
determination of a still available number of units of the resource in the case of a reservation of one or more units of the resource by one or more control computers,
use of the reserved units of the resource only for measurement procedures which are triggered by the respectively reserving control computers, and
use only of available units of the resource for measurement procedures which are triggered by arbitrary control computers.

14. The measuring method according to claim 12,
wherein only after a release of a reserved unit of the resource by the reserving control computer and/or after an expiry of a specified first time interval, the reserved unit of the resource is used by measurement procedures not triggered by the reserving control computer.

15. The measuring method according to claim 12,
wherein in the case of a reservation attempt by a control computer at a time at which no unit of the resource is available, this is communicated to the respective control computer.

16. The measuring method according to claim 11,
wherein a reservation of a unit of the resource and a release of a unit of the resource is implemented by means of SCPI commands from the respective control computer to the measuring device (30).

17. The measuring method according to claim 11,
wherein a key is transmitted to a reserving control computer in the case of a reservation of a unit of the resource, and
wherein a release of the unit of the resource is implemented only in the case of a communication of the key by the reserving control computer.

18. The measuring method according to claim 12,
wherein measurements are implemented simultaneously on several devices under test,
wherein, after a first synchronisation point, a number L of completed measurement procedures up to the expiry of a second time interval after completion of a first measurement procedure is determined, and
wherein, after a second synchronisation point, the method waits until the second time interval has elapsed or L measurement procedures have been completed.

19. A computer program with program-code means for the implementation of all of a measuring method,
wherein control computers control a measuring device for the execution of measuring procedures, and
wherein the measuring device has at its disposal at least one unit of a resource which can be used only by one measurement procedure at a time.
